(19) United States
(12) Patent Application Publication
(10) Pub. No.: US 2004/0228077 A1
(43) Pub. Date: Nov. 18, 2004

(54) Height adjustable computer monitor and document holder

(76) Inventors: Rick S. Hall, Coquitlam (CA); Jordan A. Myers, Coquitlam (CA); Carson Au, Burnaby (CA); Sheldan W Myers, Williams Lake (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/825,133

(22) Filed: Apr. 16, 2004

Related U.S. Application Data
(60) Provisional application No. 60/463,044, filed on Apr. 16, 2003.

(51) Int. Cl. G06F 1/16

(52) U.S. Cl. 361/681; 248/917

(57) ABSTRACT

A laptop computer has a height adjustable monitor and document holder to allow for ergonomic viewing. The height adjustable monitor and document holder can be utilized as separate entities and can be incorporated in laptop or desktop computers. The actuating system for the height adjustable monitor comprises a small diameter motor that is used to power a lightweight, high mechanical advantage gear train comprising a worm gear system and “lifter gears” with an “eccentric pin” drive to raise or lower the monitor, and also features a built-in locking mechanism. The actuating system has been designed to fit within currently produced laptop cases. A “split-housing” design is used so that the monitor and frame moves independently of the rear lid. The document holder resides in a storage compartment resting on the top surface of the monitor and comprises thin rectangular members that retract from the side of the compartment through a spring-release mechanism. The document holder incorporates a “T” shape with a lower shelf that allows for mounting of documents. The document holder rises and tilts in conjunction with the monitor and can also rotate about a vertical axis to allow for optimum viewing. An alternative embodiment of the document holder exists as a detachable version.

### REFERENCE TO RELATED APPLICATION

This application claims the benefit under 35 U.S.C. §119 of U.S. patent application Ser. No. 60/463,044 entitled “HEIGHT ADJUSTABLE LAPTOP COMPUTER MONITOR AND DOCUMENT HOLDER”, which is incorporated herein by reference.

### TECHNICAL FIELD

The invention relates to a height adjustable monitor and a document holder therefor.

### BACKGROUND

With traditional laptop computers, if the keyboard is in the proper position to maintain neutral wrist and shoulder posture, the monitor will be positioned too low for neutral neck posture. Raising the monitor to an appropriate height so that the neck is in a neutral posture, wherein the top of the monitor is at eye level, results in awkward shoulder and wrist posture due to the user straining to reach the keyboard.

In a comparison between desktop and laptop computers, Straker et al. (“A comparison of the postures assumed when using laptop computers and desktop computers”, Applied Ergonomics; 28(4):263-8, (1997)) and Saito et al. (“Ergonomics evaluation of working posture of VDT operation using personal computer with flat panel display.” Industrial Health, 35, 264-270, (1997)) found that there was significantly greater forward head inclination (also known as “neck flexion”) with laptop use. Harbison et al. (“The ergonomics of notebook computers: problems or just progress?” Journal of Occupational Health and Safety—Aust NZ, 11 (5):481-487, (1995)) reported that the average neck flexion for the laptop users in their study was 45 degrees. Harbison et al. stated that the subjects in their study reported increased discomfort in their neck and upper thoracic regions when using their laptops. The authors concluded that the forward neck angle was considerably greater than the recommended viewing angle for screens and this was likely to cause significant loading on the neck muscles. They suggested that detachable screens could alleviate this problem, by allowing the user to place the screen much higher than the current designs permit. However, they noted that this would only work if there were a suitably elevated surface on which to place the screen. The researchers also noted that portable document holders might help, since their subjects tended to place reference documents on the desk to the side of the keyboard, which increased the tendency to flex the neck (to see the documents).

In order to view documents on a desk surface, the degree of neck flexion required is even greater than that required to view the monitor, due to the low position and angle of the document with respect to the individual's line of sight. In addition, neck rotation is often required if the document is placed to the side of the laptop. The combination of static neck flexion and rotation further increases the risk for neck injury.

According to the Workers' Compensation Board of British Columbia (MSI risk factor assessment worksheets A and B, (2001) (“MSI” stands for “musculoskeletal injury”), static neck flexion of greater than 30 degrees maintained for more than 2 hours total per day results in a moderate risk for injury, and static neck flexion of greater than 45 degrees maintained for more than 4 hours total per day results in a high risk of musculoskeletal injury to the neck region. The U.S. Center for Disease Control (CDC) (Computer Workstation Ergonomics: Laptop Computers) states: “Laptop computers are not recommended as primary computers. In the office or while at home, a docking station is recommended to provide adjustability which will enhance neutral postures. Maintaining neutral postures will reduce stress and strain to the musculoskeletal system. Keep your head and neck in a neutral posture; avoid excessive neck flexion and rotation.”

Saito et al. found that there was greater neck muscle activity, as measured by electromyography (EMG) in laptop users while Villanueva et al. (The human factors of notebook PCs. Evaluation of posture and muscle activities, Proceedings of the 5th Pan-Pacific Conference on Occupational Ergonomics, 1998) found that there was greater neck discomfort and muscle activity in laptop users as compared to desktop users. Harris et al. (“Survey of physical ergonomics issues associated with school childrens' use of laptop computers”, International Journal of Industrial Ergonomics, (2000)) reported that 60% of 251 students between the ages of 10 and 17 who used laptops experienced muscular discomfort, with the most common site of discomfort being the neck. Heasman et al. (Health and safety of portable display screen equipment, Contract research report prepared for the Health & Safety Executive, United Kingdom, (2000)) reported that Unison, a union organization in the United Kingdom, conducted a survey of 500 career advisors who used laptops and found that 60% suffered neck pain (47% “occasional to frequent”) while 61% suffered back pain (47% “occasional to frequent”).

Several manufacturers have developed height adjustable support stands for laptop computers to raise the height of the monitor to an appropriate level. The disadvantages to using a height adjustable stand include: 1) it requires the use of an external keyboard and mouse to keep the user's shoulders and wrists in a neutral posture, 2) it can only be used on a flat surface that has adequate space for the stand, keyboard, and mouse, and 3) it decreases the portability of the laptop.

Due to the close proximity of the laptop monitor to the user, a standard laptop monitor requires significant backward tilting to allow the user to have his/her line of sight perpendicular to the monitor for optimum viewing (the CDC recommends that the screen be angled so that it is perpendicular to the user's line of sight, if lighting permits); this results in the monitor being lower to the working surface, which further tends to increase the angle of neck flexion, as shown in FIG. 1A. Increasing the angle of tilt of the monitor may also result in increased glare from overhead lighting; such glare can increase the risk for eyestrain. A height adjustable monitor and document holder would help to maintain neutral posture of the neck, shoulders and wrists while maintaining portability of the laptop. Assuming a viewing distance of approximately 20 inches, a 6 inch rise in monitor height will result in a reduction in the angle of neck flexion by approximately 30 degrees (from 45 degrees to 15 degrees, see FIG. 1B), which is considered to be low risk and acceptable by the Workers' Compensation Board of British Columbia, as reported in MSI risk factor assessment worksheet A, (2001).

Spaniol et al. (U.S. Pat. No. 5,229,920) disclose a monitor with vertical adjustment whereby the monitor rises upward along a holding arm. Spaniol et al. also disclose an alternate method of using telescoping arms.

Margaritis (U.S. Pat. No. 5,729,429) discloses a height adjustable monitor that can be adjusted by controllably extendable support members or a freestanding controllably extendable support base. Margaritis further discloses the use of additional weight in the base of the computer or support members attached to the rear of the computer to maintain stability of the computer when the monitor is extended upward and tilted backward.

Tran et al. (U.S. Pat. No. 5,805,415) disclose a detachable monitor that can be placed on a height-adjustable stand for comfortable viewing.

Meyer (U.S. Pat. No. 6,076,786) discloses a display adjustment mechanism enclosed in a compartment behind the display screen and a portion of the compartment that slides as the user lifts the display upward from its lowest position. The display can also be rotated 180 degrees in either direction and tilted forward or back.

Osgood (U.S. Pat. No. 6,233,138 B1) discloses a monitor using a telescoping pivot hinge that raises the entire monitor.

Kramer (U.S. Pat. No. 6,381,128) discloses a portable computer having a main computer body and a monitor that is attached to the main computer body via a sliding mechanism and moveable to various positions up and away from the main computer body. The main computer body is shaped in the form of an arc; therefore the monitor moves along an arc when it extends upward.

Iredale (U.S. Pat. No. 6,392,877) discloses a computer having a display support member of a display module mounted to a rail support assembly for sliding movement along the rail assembly upward from the keyboard module when the display module is rotated to an open position. The display panel is positioned high enough above the keyboard to allow for access to the keyboard while maintaining a comfortable viewing angle. Iredale cites the value of this assembly in compensating for use of the laptop in confined spaces such as airline seats.

Agata et al. (U.S. Pat. No. 6,504,707) disclose a height adjustable monitor in which the monitor comes forward away from the rear lid and raises upward, with a portion of the rear lid also coming forward. A mechanical linkage arm attached to both sides of the monitor allows the monitor to pivot outward and upward, resulting in a space between the screen and rear lid. Agata et al. used this type of design so that the laptop could be operated in confined spaces such as on airplane seats.

Raphael-Leff et al. (U.K. Patent No. 9,923,024.5) disclose a monitor using a sliding mechanism containing rods and tubes that can be rotated in different directions about a long axis running perpendicular to the computer base.

Hideo (Japan Patent No. JP7234743) discloses a monitor attached to a telescoping arm that can be rotated about its long axis. The device comprises a mechanism to fix the monitor in place.

Karidis et al. (U.S. Pat. No. 6,229,693) discloses a laptop computer in which the monitor comes forward away from the rear lid and raises upward.

Adams et al. (U.S. Pat. No. 5,697,594) discloses a detachable grasping apparatus for portable computers comprising a clamp and an elongated clamp or clip movably interconnected in between by means of a plurality of pivoting mechanisms. The clamp secures the apparatus to a surface, such as a portable computer, without permanently being mounted to the surface. The clip holds large shaped materials such as documents, paper, and the like.

Bakanowsky (U.S. Pat. No. 5,104,088) discloses a document holder clip comprising a right angle support bracket to be secured to the side of a monitor screen, an extending arm pivotably engaged with the support bracket and a document holder clip adaptable for slidable movement on the upper edge of the extending arm.

### SUMMARY OF INVENTION

The invention provides a height adjustable monitor assembly for a laptop computer. The monitor assembly includes a screen assembly which slides independently of the lid of the monitor, which preferably remains fixed during height adjustment. Upward movement of the screen assembly in relation to the rear lid allows for improved stability in the case where the monitor is tilted backward, due to the center of gravity of the monitor assembly remaining lower and closer to the pivot point of the monitor assembly and computer base. Another advantage is that the lid will remain in close contact with the keyboard, which will eliminate the potential safety hazard created by a gap between the lid and keyboard, in the case where the user's hand or fingers may become entrapped in the gap during downward descent of the monitor. Elimination of this gap will also help to eliminate any lighting/glare that could potentially emanate through the gap, which could interfere with viewing of the monitor. Also, the aesthetics of the laptop are enhanced by the elimination of this gap. The lid preferably also remains in close contact with the screen assembly, thereby minimizing the likelihood that debris or a user's fingers will get caught between the lid and the screen assembly during movement of the screen assembly, and reducing the likelihood of breakage.

Any potential problems associated with the ascent/decent of the monitor could be eliminated with a wireless optic/radio frequency link between CPU and monitor. It is also possible to use conventional sliding electrical contacts to complete the CPU-to-monitor interface in the event that the optic/RF link design proves uneconomical, impractical, or otherwise unfeasible to manufacturers. Electrical power to the monitor could be provided by sliding electrical contacts or wiring.

The invention also provides a worm gear system and lifter gears with an eccentric pin drive. A lightweight gear system with high mechanical advantage will result in little added weight and low power requirements for the motor, resulting in minimal power drain on the battery. There will be little added thickness to the laptop due to molded indentations in the rear lid that the gears and motor assembly will be mounted in. A high-strength material such as glass-filled nylon or the like can be used for the monitor backing and frame, which will result in an extremely strong, lightweight, and thin material. The gear assembly is preferably protected from the elements by a wiper seal mounted on the bottom front portion of the monitor, and the rear top portion of the lid. This should act as an effective barrier to prevent dust or debris from coming into contact with the gear system.

The invention also provides a document holder, which adjusts for optimum viewing angle with monitor height. The document holder may be permanently attached to the monitor, or it may be detachable. A height-adjustable document holder will add ergonomic viewing for any documents being read during operation of the laptop monitor.

### BRIEF DESCRIPTION OF DRAWINGS

In drawings which illustrate non-limiting embodiments of the invention:

FIG. 1A is a stick figure drawing showing the orientation of a user's head while using a standard laptop, demonstrating the angle of neck flexion, according to the prior art;

FIG. 1B is a stick figure drawing showing the orientation of a user's head while using a laptop with a raised monitor, demonstrating the decrease in the angle of neck flexion, according to the prior art;

FIG. 2A is a sectional front view of a monitor assembly according to a preferred embodiment of the invention in a lowered position;

FIG. 2B shows the monitor assembly of FIG. 2A in a raised position;

FIG. 3 is a sectional top view of the monitor assembly of FIG. 2A;

FIG. 4 is a sectional top view of a monitor assembly according to another preferred embodiment of the invention;

FIG. 5A is a sectional front view of a monitor assembly according to an alternative embodiment of the invention in a lowered position, with a motor mount in a locked position;

FIG. 5B shows the monitor assembly of FIG. 5A in a raised position, with the motor mount in an unlocked position;

FIG. 6 is a sectional front view of a monitor assembly according to an alternative embodiment of the invention in a lowered position;

FIG. 7 is a sectional front view of a monitor assembly according to an alternative embodiment of the invention in a lowered position;

FIG. 8A is a rear view of a laptop computer according to an alternative embodiment of the invention, wherein stabilizing components are attached to the rear of the computer's base;

FIG. 8B is a side view of the computer of FIG. 8A, with the monitor assembly in the raised position;

FIG. 9A is a sectional side view of a monitor assembly and actuating mechanism according to a preferred embodiment of the invention, with the monitor assembly in the raised position;

FIG. 9B is a sectional side view of a monitor assembly and actuating mechanism according to an alternative embodiment of the invention, with the monitor assembly in the raised position;

FIG. 10A is a front view of a laptop computer with a monitor assembly having a document holder according to another preferred embodiment of the invention;

FIG. 10B is a rear view of the laptop computer of FIG. 10A with the support members in a folded position;

FIG. 11A is a front view of the posterior arm and the folded support members of the document holder of FIG. 10B;

FIG. 11B is a rear view of the anterior arm of the document holder of FIG. 10B;

FIG. 11C is a top view of both of the arms of the document holder and the folded support members of FIG. 10B in a storage position;

FIG. 11D is a bottom view of the document holder of FIG. 10B;

FIG. 12 is an end view of a housing for a document holder according to one embodiment of the invention;

FIG. 13 is a sectional view of an anchor member and posterior member of the document holder of FIGS. 10A-11D;

FIG. 14 is an isometric view of a laptop computer with a height adjustable monitor assembly and a document holder according to one embodiment of the invention; and,

FIG. 15 is an isometric view of a laptop computer with a height adjustable monitor assembly according to one embodiment of the invention.

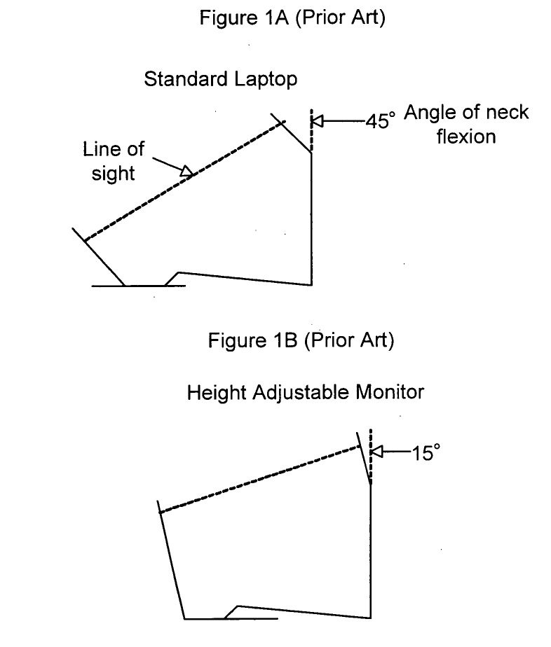

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

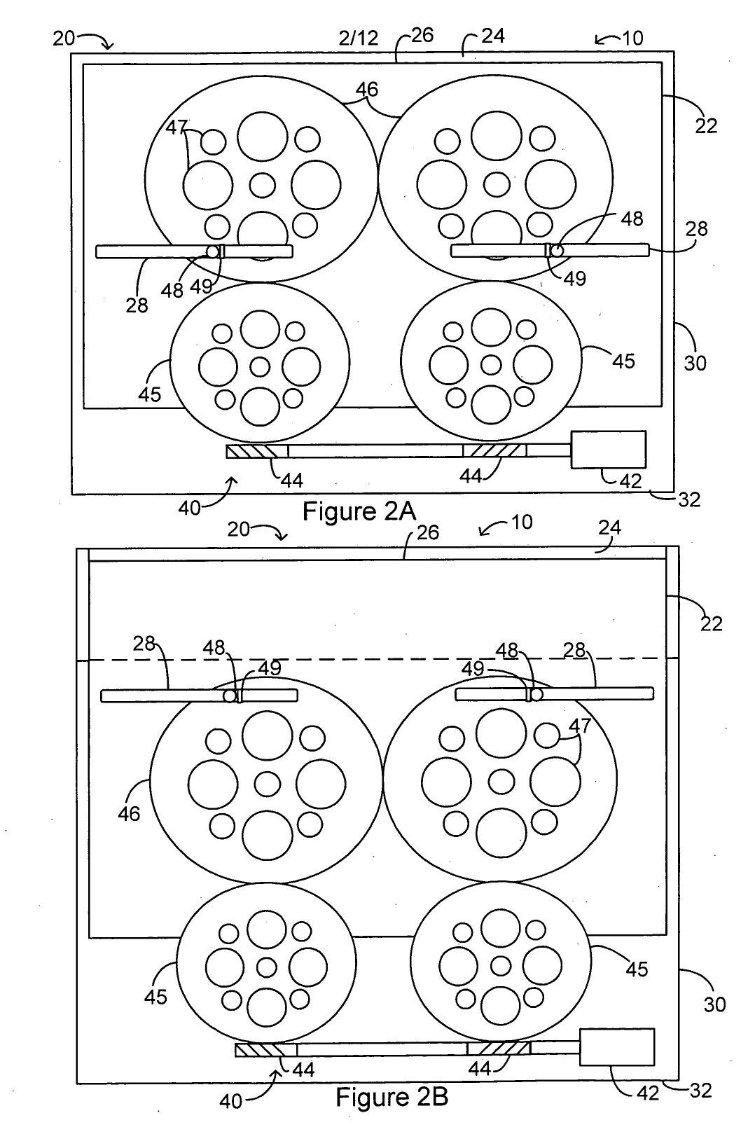

FIGS. 2A and 2B illustrate a preferred embodiment of a monitor assembly 10 according to the invention, in a lowered and a raised position, respectively. Monitor assembly 10 preferably comprises screen assembly 20, lid 30, and actuating mechanism 40. Screen assembly 20 preferably comprises screen 22 within a housing which preferably comprises frame 24 and screen backing 26. Frame 24 and screen backing 26 are preferably constructed from a high-strength material such as glass-filled nylon or aluminum to protect screen 22 from damage. Slots 28 are formed in screen backing 26 to facilitate raising and lowering of screen assembly 20, as described below.

Lid 30 is preferably pivotally attached to the base of the laptop (not shown in FIGS. 2A and 2B) at bottom edge 32. Lid 30 is configured to slidably receive screen assembly 20, as described below. Actuating mechanism 40 is preferably attached to lid 30, between lid 30 and screen assembly 20.

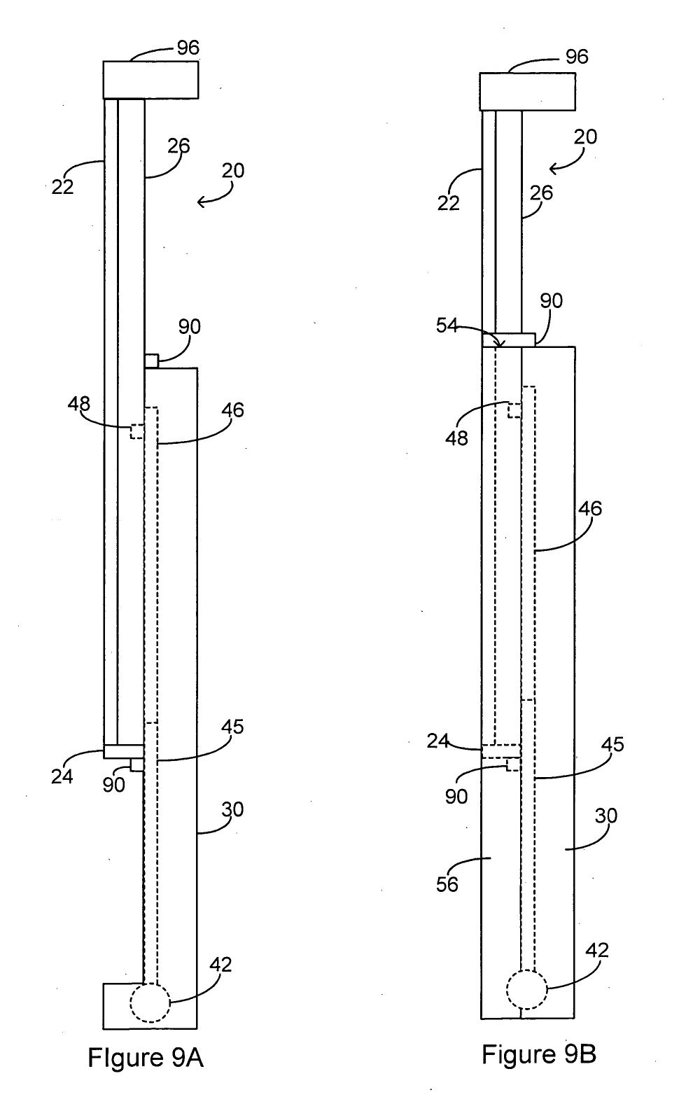

In the preferred embodiment, actuating mechanism 40 comprises a gear system including a single-shaft motor 42, worm gears 44 mounted on a shaft of motor 42, a meshing gear 45 associated with each worm gear 44, a lifter gear 46 associated with each meshing gear 45, and a drive pin 48 on each lifter gear 46. A limit switch 49 is situated near the midpoint of each slot 28. Motor 42 is preferably a high RPM, low noise motor mounted in an indent in lid 30 below screen assembly 20. Motor 42 is positioned such that the axis of rotation of its drive shaft is aligned with the midpoints of meshing gears 45 as shown in FIGS. 9A & 9B.

Positioning motor 42 and its drive shaft below screen assembly 20 allows lifter gears 46 and meshing gears 45 to be placed closer to the rear of screen assembly 20 and minimizes any rearward displacement of motor 42 in lid 30. One worm gear 44 is a right-hand helix, the other is a left-hand helix. Lifter gears 46 are rotationally mounted on lid 30 and positioned so as to be engaged by their associated meshing gears 45, which are positioned so as to be engaged by their associated worm gears 44. Lifter gears 46 may also be meshed with one another along the mid-point of the medial aspect of each lifter gear 46 to ensure that lifter gears 46 remain in proper alignment in the event that worm gears 44 are disengaged during manual lowering of the monitor, as described below. A cover (not shown) can be provided to protect and conceal meshing gears 45 and lifter gears 46 when screen assembly 20 is in the raised position. Drive pins 48 are configured to be slidably received within slots 28 in screen backing 26. Limit switches 49 function to deactivate motor 42 so as to cease rotation of lifter gears 46 when screen assembly 20 is in a fully raised or fully lowered position. Slots 28 preferably each have a length approximately equal to the diameter of lifter gears 46. Meshing gears 45 and lifter gears 46 are preferably thin (for example, having a thickness of about 2 millimeters) and manufactured from a lightweight, high-strength material such as glass-filled nylon or aluminum, and preferably have a plurality of holes 47 therein, to reduce the weight of gears 45 and 46. Drive pins 48 are preferably located near the rims of lifter gears 46 and preferably comprise bearings of a suitable material such as nylon.

In operation, activation of motor 42 turns worm gears 44, which in turn rotate meshing gears 45 which cause one lifter gear 46 to rotate clockwise and the other to rotate counter-clockwise. Drive pins 48 slide in slots 28 as lifter gears 46 rotate, thereby transforming the rotational motion of lifter gears 46 into linear motion of screen assembly 20. Accordingly, operation of motor 42 in one rotational direction raises screen assembly 20, and operation of motor 42 in the opposite rotational direction lowers screen assembly 20. The range of motion of screen assembly 20 will thus be approximately equal to the diameter of lifter gears 46.

The benefits of using a worm gear drive include:

1) A worm gear drive allows for a very low overall gear ratio, for example, in the range of 300:1 to 500:1. Thus motor 42 has significant mechanical advantage and does not experience the wear and strain associated with high loads. This allows the use of a low-noise motor. Low noise motors are typically high-speed/low torque devices.

2) The nature of a worm gear is such that it can turn a meshing gear, but the meshing gear cannot turn the worm. Thus this design has a built-in locking mechanism, whereby the screen is secure and cannot be moved by outside forces regardless of its position.

3) A worm gear is typically associated with a low gear ratio and precise gear movement, thus it theoretically allows for an infinite number of monitor positions that can be accurately controlled by the user.

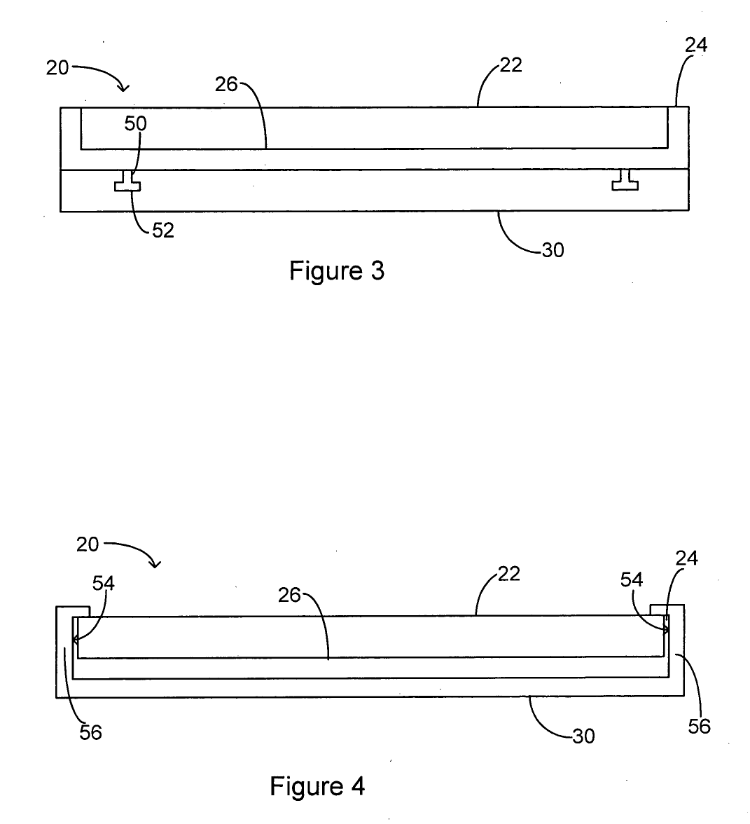

FIG. 3 illustrates how screen assembly 20 is slidably attached to lid 30 in the preferred embodiment of the invention. T-rails 50 are provided on the rear of screen backing 26. Correspondingly shaped T-slots 52 are formed in lid 30. Screen backing 26 and T-rails are preferably manufactured from the same material as lid 30, or from some similar high-strength, resilient material. As screen assembly 20 is moved up and down by actuating mechanism 40, T-rails 50 slide in T-slots 52. The shape of T-rails 50 and T-slots 52 ensures that screen assembly 20 and lid 30 remain in close proximity during movement of screen assembly 20. T-slots 52 are preferably approximately equal in length to the range of motion of screen assembly 20, and are preferably located as close to the perimeter of lid 30 as design allows.

FIG. 4 illustrates an alternative embodiment of the invention, wherein screen assembly 20 slides within channels 54 formed by flanges 56 on the lateral edges of lid 30. Channels 54, while preferably being made of the same material as lid 30, are preferably coated with a low-friction material, such as Teflon™, to facilitate sliding movement, of screen assembly 20 parallel to lid 30. As one skilled in the art will appreciate, many variations of the mechanism which slidably connects screen assembly 20 to lid 30 are possible without departing from the spirit or scope of the invention.

Software running on the laptop computer is preferably used to control the height of screen assembly 20. To move screen assembly 20, the user would enable the appropriate software command, or keyboard button as dictated by the software (eg: “F1” for up, “F2” for down), or one of 2 momentary-contact switches, which may also include one or more of any type of: a) sliding contact switch, b) rotational switch, or c) lever switch. The switches could be placed at the manufacturer's discretion, but a location next to the monitor would be logical.

Software according to the invention may also preferably incorporate other desirable features such as:

1) The software would signal the user when battery power has reached a point of low reserve; for example, 25% of maximum. This would allow the user time to lower screen assembly 20 before battery exhaustion occurs. Additionally, the software would automatically lower screen assembly 20 if a predetermined power level is reached, for example 20% of maximum, to prevent the screen from remaining fixed in the raised position. If the monitor was left in the raised position during computer shut-down, the software may automatically lower the monitor before shut-down is allowed.

2) The software may store multiple users' height settings for screen assembly 20 in memory and allow users the option of automatically raising screen assembly 20 to their pre-set height upon activation of the height adjustable monitor function. The software memory could be bypassed, for example, by use of the momentary contact switches.

A laptop computer according to one embodiment of the invention may also incorporate a wireless link comprising infrared transmitters and receivers (not shown) that allow for transmission of video and audio signals between the CPU and screen assembly 20. Alternatively or additionally, the computer may incorporate a wireless link comprising radio frequency (RF) transmitters and receivers (not shown). In another embodiment, sliding electrical contacts (not shown) are provided that allow for transmission of video and audio signals between the CPU and screen assembly 20. In another embodiment, wiring (not shown) is provided that allows for transmission of video and audio signals between the CPU and screen assembly 20. A laptop computer according to another embodiment of the invention may also incorporate sliding electrical contacts or wiring to allow for transmission of power to screen assembly 20.

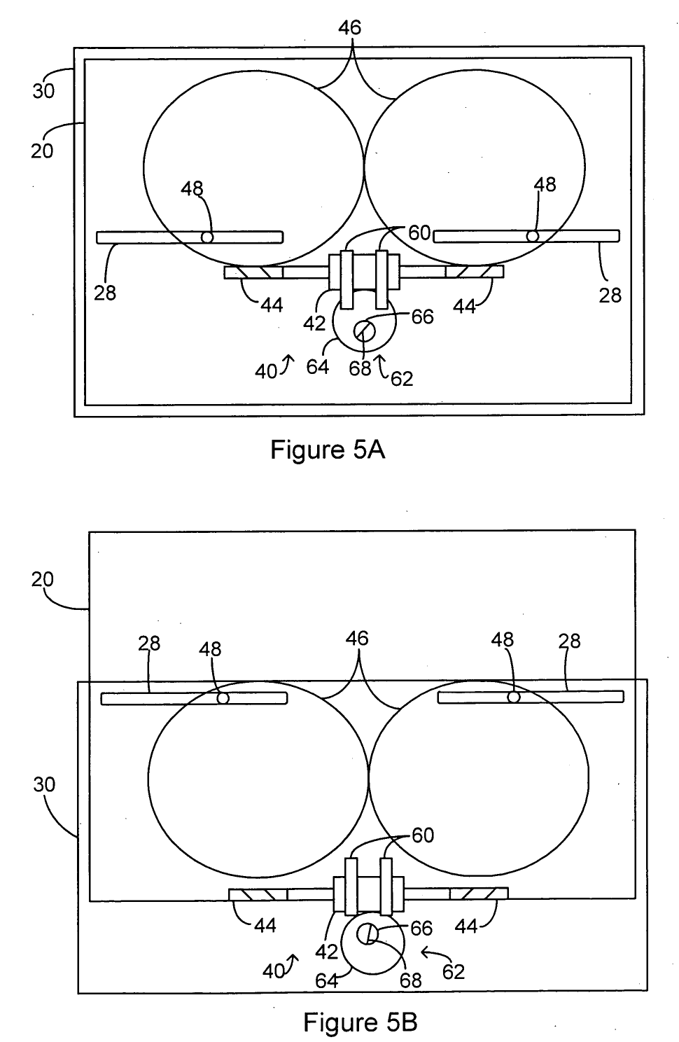

In another embodiment of the invention, as shown in FIGS. 5A and 5B, a sliding motor mount 60 to facilitates manual actuation of screen assembly 20 in the event of power failure. Mount 60 allows movement of motor 42 and worm gears 44 between an engaged position (FIG. 5A) wherein worm gears 44 engage lifter gears 46, and a disengaged position (FIG. 5B) wherein worm gears 44 do not engage lifter gears 46.

In the embodiment of FIGS. 5A and 5B, an eccentric mechanism 62 is attached to lid 30 to selectively lock motor 42 in the engaged position. Eccentric mechanism 62 may comprise an eccentric member 64 attached to a shaft 66 with a slot 68 therein extending out the back of lid 30. Eccentric mechanism 62 bears against motor 42 to maintain motor 42 in the engaged position when in normal operation. To unlock motor 42 from the engaged position, a user can place a coin or other thin object in slot 68 and turn shaft 66, which moves eccentric member 64 away from motor 42. Once eccentric member 64 has been moved, motor 42 is free to slide vertically within mount 60 between the engaged and disengaged positions. As a result screen assembly 20 could be moved into the lowered position by outside forces (eg: a push from the user). Lifter gears 46 are preferably thin and have tight tolerances, so it would take very little movement of motor 42 to achieve a disengaged position. A spring or compressive material (not shown) is preferably located on the side of motor 42 opposite eccentric mechanism 62 in order to bias motor 42 into a disengaged position such that motor 42 automatically moves into a disengaged position when eccentric member 64 is moved away from motor 42. If power were lost, the user would turn shaft 66 to move motor 42 into a disengaged position. This would allow a user to manually push screen assembly 20 into the lowered position, and lock it by turning shaft 66 to move eccentric member 64 and force motor 42 into the engaged position.

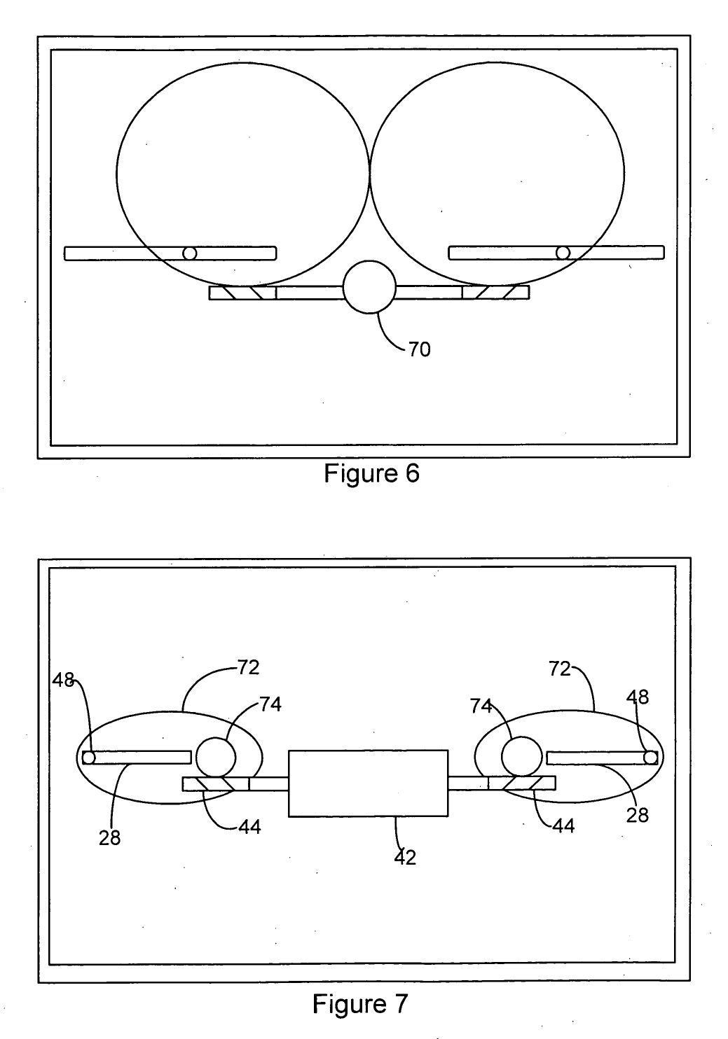

FIGS. 6 and 7 illustrate alternative embodiments of the invention. The FIG. 6 embodiment is similar to the embodiment of FIGS. 2A-B, but motor 42 instead comprises a conventional thin motor 70 configured to drive worm gears 44 by means of a right-angle drive such as a helical gear. The FIG. 6 embodiment is less bulky than the embodiment of FIGS. 2A-B, in that a thin motor is used, but this arrangement would result in a reduction in gear ratio as compared to the embodiment of FIGS. 2A-B, which in turn would result in the need for a higher RPM motor. Motor 70 may also be positioned below screen assembly 20 as in the embodiment of FIGS. 2A & 2B with a single drive shaft and meshing gears that are positioned between the worm gears and lifter gears (not shown in FIG. 6).

The FIG. 7 embodiment uses the same motor 42 as the embodiment of FIGS. 2A-B, but lifter gears 46 are replaced with eccentric cams 72. Idler gears 74 are meshed with worm gears 44 to drive eccentric cams 72. Drive pins 48 are mounted on the lateral apex of cams 72. Drive pins 48 slide in slots 28 in the screen backing 26 as eccentric cams 72 rotate, thereby transforming the rotational motion of cams 72 into linear motion of screen assembly 20 in a manner similar to the embodiment of FIGS. 2A-B. Preferably, eccentric cams 72 have a plurality of holes therein (not shown) to reduce the weight of cams 72. This gear system allows for a higher speed of rotation with an associated decrease in mechanical advantage. Motor 42 of FIG. 7 may also be positioned below screen assembly 20 as in the embodiment of FIGS. 2A & 2B with a single drive shaft and meshing gears that are positioned between the worm gears and lifter gears (not shown in FIG. 7).

As one skilled in the art will appreciate, the basic “eccentric pin” drive embodiment of actuating mechanism 40 discussed above in relation to FIG. 2A-B is flexible enough to take on several forms. This includes the eccentric cam embodiment shown in FIG. 7, a cam within a cam (powered eccentric within a static “cut-out” eccentric or circle), the use of a single motor to power both lifter gears which are intermeshed with each other, or a single motor and single lifter gear; all of which could be powered by virtually any compact DC electric motor. Alternatively, actuating mechanism 40 could incorporate more than one motor. As a further alternative, actuating mechanism 40 could incorporate one or more idler gears intermeshed between worm gears 44 and lifter gears 46. As a still further alternative, actuating mechanism 40 could incorporate a dual-shaft motor with a worm gear mounted on each shaft. As a yet further alternative, the motor and drive shaft assembly could be mounted at any location on lid 30.

Actuating mechanism 40 could also optionally incorporate: 1) a rack and pinion gear system; 2) a chain-drive gear system; 3) a belt-drive gear system; 4) a friction wheel system; 5) a scissors mechanism; 6) a spring-loaded mechanism in which the user loads the spring by manually pushing the screen down—depressing a button/switch/lever releases the spring and the stored energy is used to raise the screen; or 7) a polarized lifter gear system whereby the lifter gears possess magnetic surface areas about their perimeter and create rotational torque when mating electromagnets, mounted in the monitor housing, are energized.

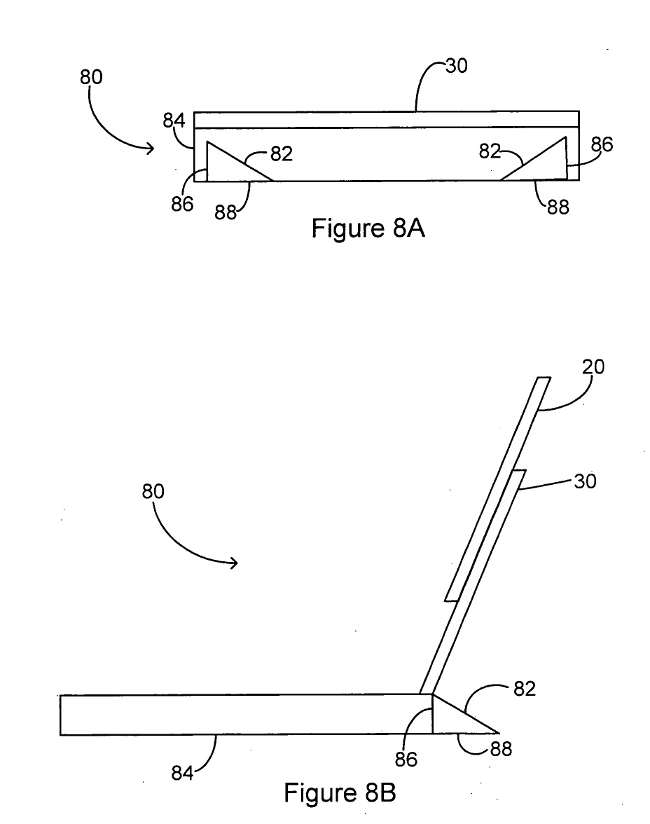

FIGS. 8A and 8B illustrate a laptop computer 80 according to an alternative embodiment of the invention. In recognition of potential instabilities associated with increasing a monitor's height relative to its keyboard, stabilizing components may be provided. In the illustrated embodiment, stabilizing components comprise dual triangular supports 82 mounted to the rear lateral aspect of the laptop base 84. The supports 82 are attached to the base by vertical hinges 86 that lock when supports 82 are rotated 90 degrees relative to base 84 (in the extended position). The inferior aspects 88 of supports 82 are preferably flush with the bottom of the laptop. Supports 82 may include holes (not shown) to allow access to electrical connectors (e.g. USB, power jacks, modem connection, etc.) when supports 82 are in the closed position.

Other options for stabilizing components include: 1) telescoping stabilizing members at the rear lateral aspect of the CPU housing. The stabilizing members contain a telescoping piece that can be disengaged/engaged by means of a button release. The members are attached to the rear lateral aspects on the upper edge of the CPU housing with horizontally mounted hinges. The hinges have a built-in stop to limit rearward rotation to 45 degrees, thereby keeping them in a stable position once extended from their stored position, and 2) pullout stabilizing members that extend from the bottom of the laptop base and extend rearward with the distal section pivoting about a transverse hinge and folding towards and attaching to the computer base.

FIGS. 9A and 9B illustrate embodiments of the invention which incorporate seals 90 to prevent dust or debris from coming into contact with the actuating mechanism 40. FIG. 9A illustrates preferred positions of seals 90 for the preferred embodiment shown in FIG. 3. FIG. 9B illustrates preferred positions of seals 90 for the channel embodiment of FIG. 4. Each seal 90 preferably comprises a wiper seal, or other suitable seal. Seals 90 are preferably mounted on the bottom front portion of the monitor, and the rear top portion of the lid. In the FIG. 9B embodiment, seals 90 are also mounted along the top portion of channels 54. The embodiments of FIGS. 9A and 9B also include a compartment 96 for storing a document holder, as described below.

Document Holder

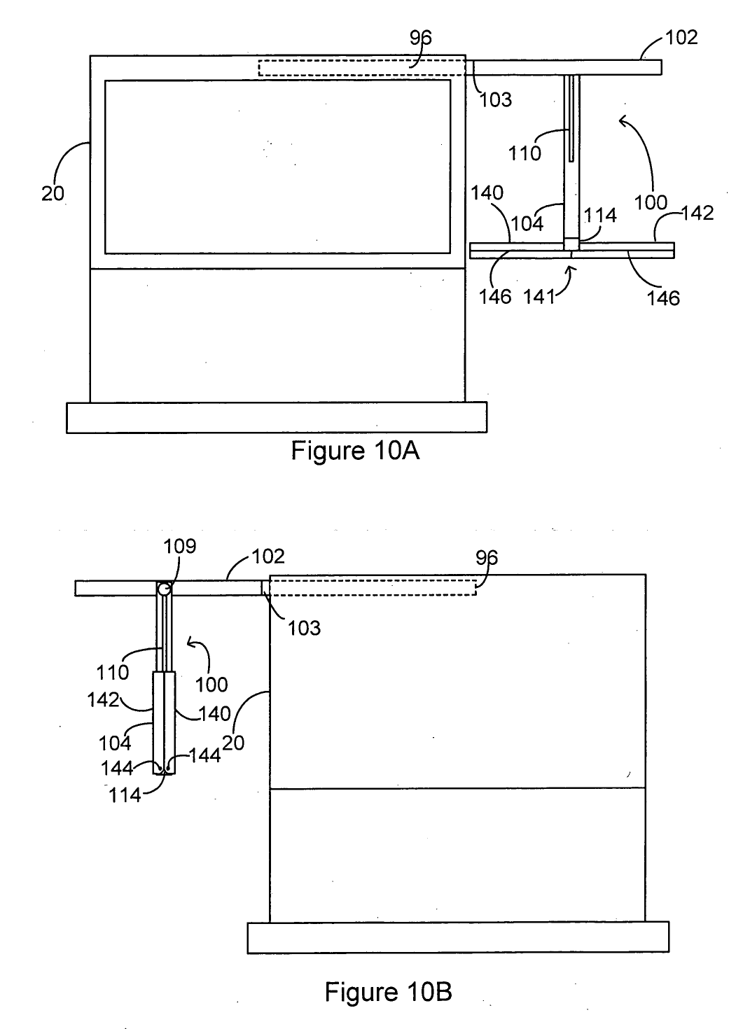

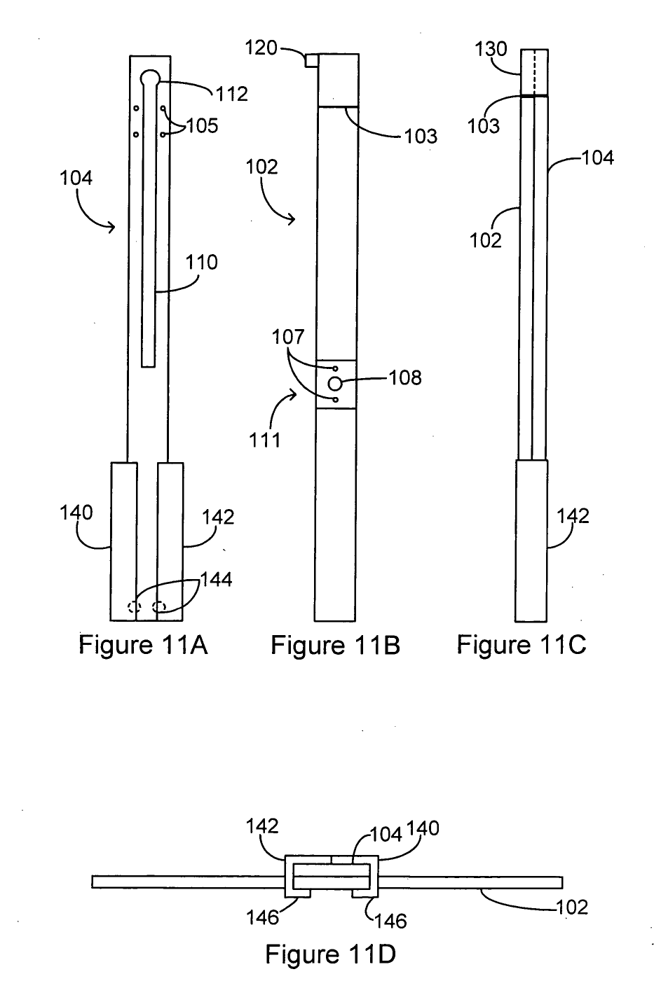

Some embodiments of the invention also provide a document holder 100 housed along the top of screen assembly 20. In the preferred embodiment, as shown in FIGS. 10A-B and 11A-D, document holder 100 comprises anterior and posterior rectangular members 102, 104, respectively. Members 102, 104 are joined by a pivot 108 extending from the rear of anterior member 102. Pivot 108 may optionally comprise a thumb screw 109, as shown in FIG. 10B, so that anterior and posterior member 102, 104 may be held in fixed relation to one another. Posterior member 104 has a slot 110 therein with an enlarged end 112. Slot 110 and enlarged end 112 are configured to slidably receive pivot 108 to allow posterior member 104 to slide from the storage position shown in FIG. 11C and rotate 90 degrees downward into an operative position shown in FIG. 10A.

Attached to a distal end 114 of posterior member 104 is a “J”-shaped shelf 141 comprising two rectangular support members 140, 142. A hinge 144 is located near the distal edge of each support member 140, 142 to allow support members 140, 142 to be folded towards posterior member 104, as shown in FIGS. 10B and 11D. The inner corners of support members 140, 142, and the distal end of posterior member 104, are rounded in this embodiment to allow support members 140, 142 to rotate, as shown in FIG. 10B. Support members 140, 142 form a lip 146 that extends around the front of the anterior member 102 when document holder 100 is in the storage position, as shown in FIG. 11C. When posterior member 104 is in the vertical position, the support members may be rotated downward 90 degrees to form “J”-shaped shelf to support the lower edge of a document, as shown in FIG. 10A.

Posterior member 104 is preferably sized to accommodate a number of different lengths of papers, and may optionally have protrusions 105 on the front thereof, which are configured to be received in a pair of corresponding intrusions 107 in the back of anterior member 102 near pivot 108. Anterior member 102 may also comprise a guide 111 to facilitate proper alignment of posterior member 104 therewith. Anterior member 102 may also possess a telescoping section (not shown) at its distal end to allow for viewing of documents that are positioned in a landscape orientation. Posterior member 104 may also possess a telescoping section (not shown) at distal end 114 to allow for longer documents to be secured to the document holder 100 when screen assembly 20 is raised. Anterior member 102 preferably possesses a hinge 103, which resides outside the monitor frame when document holder 100 is extended, to allow rotation about a vertical axis. Hinge 103 allows for individual adjustment of document holder 100 and prevents breakage of holder 100 or the monitor frame due to excessive force being applied in the anterior-posterior direction. Hinge 103 may comprise a conventional butterfly hinge or a ball-and-socket joint. Preferably, document holder 100 would be constructed of a highly resilient and strong material such as Lexan. An adhesive strip, preferably comprised of Pomoca, may also be placed longitudinally along the front of anterior member 102 to secure the top edge of the document. In another embodiment, the adhesive strip may be replaced with a small spring-loaded clip or other fastening mechanism.

Anterior and posterior members 102, 104 and support member 140, 142 may be placed in alignment, as shown in FIG. 11C, and stored within hollow storage compartment 96 within the upper portion of screen assembly 20. Compartment 96 may be formed within the top portion of screen assembly 20, as shown in FIGS. 10A-B.

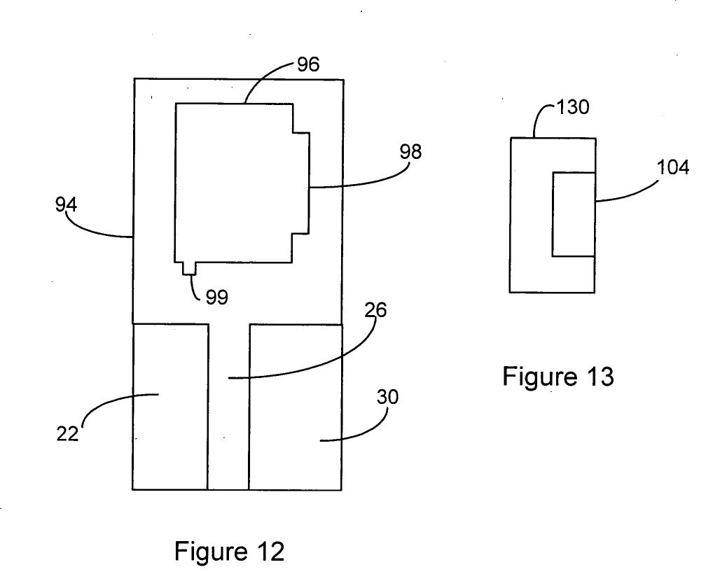

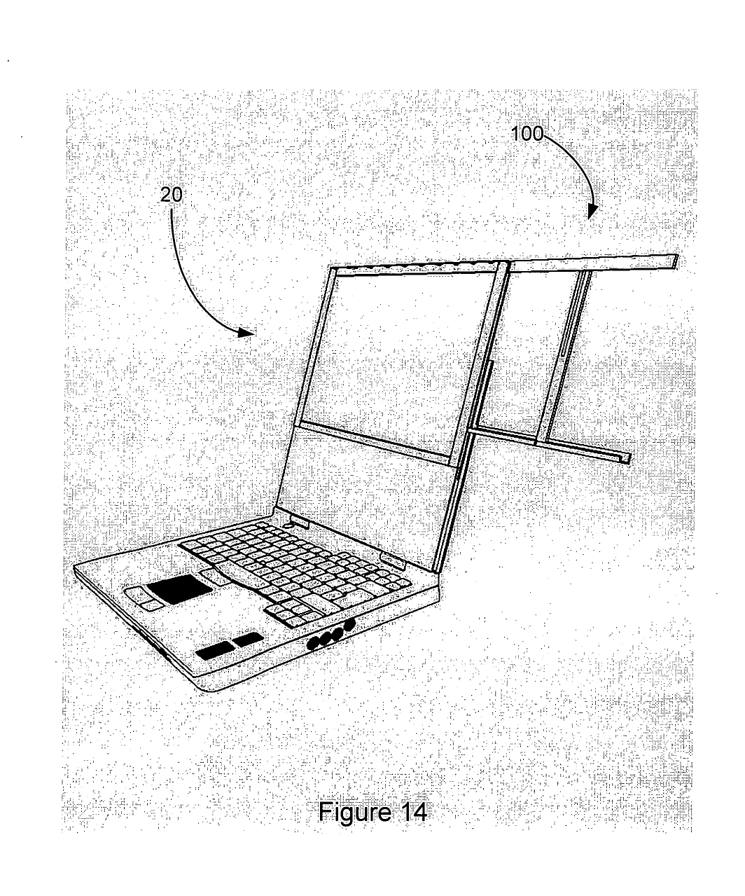

As shown in FIG. 12, storage compartment 96 may be defined by a housing 94 attached to the top of screen assembly 20 above lid 30. Compartment 96 preferably features a rectangular slot 98 along the mid-point of the posterior aspect to allow for passage of thumb screw 109. Compartment 96 also preferably features another rectangular slot 99 along its anterior-inferior aspect to allow for passage of a protrusion 120 (see FIG. 11B), which acts as a guide when members 102, 104 are extended, and also serves to stop members 102, 104 in the fully extended position. A locking device (not shown) may be added to ensure holder 100 remains fixed in the extended position. A spring (not shown) may optionally reside on the proximal end (i.e., the end closest to the mid point of screen assembly 20 when holder 100 is extended) of anterior member 102 to propel holder 100 outward once a release mechanism (not shown) is depressed. To prevent excessive anterior-posterior play of anterior member 102 when document holder 100 is deployed, a U-shaped anchor 130 or the like may be used to maintain consistent thickness in storage compartment 96, as shown in FIG. 13.

FIG. 14 shows a laptop computer with a raised screen assembly 20 according to the FIG. 3 embodiment and a document holder 100 according to the invention.

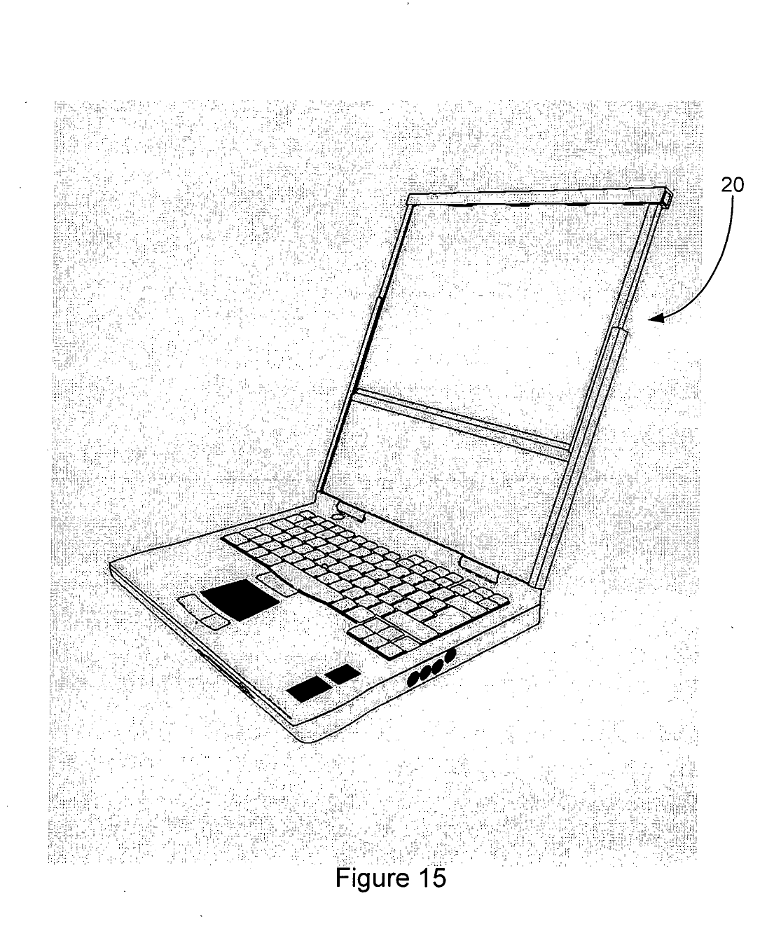

FIG. 15 shows a laptop computer with a raised screen assembly 20 according to the FIG. 4 embodiment of the invention.

The document holder according to the invention may be used in association with either laptop or desktop computers.

As will be apparent to those skilled in the art in the light of the foregoing disclosure, many alterations and modifications are possible in the practice of this invention without departing from the spirit or scope thereof. For example:

storage compartment 96 may optionally be defined in a detachable housing so as to be removable from the top of screen assembly 20 to allow for replacement of document holder 100 in the event of damage;

the detachable housing may be attached to the top of screen assembly 20 by means of spring clips or other suitable fasteners;

“J” shaped shelf 141 could be omitted in embodiments with an adhesive strip or clip-like fasteners located on anterior member 102, and distal end 114 (i.e., the end opposite the end with enlarged end 112 of slot 110 therein) of posterior member 104 may be “J”-shaped to anchor the base of the document(s) to be held by holder 100.

Accordingly, the scope of the invention is to be construed in accordance with the substance defined by the following claims.

What is claimed is:

1. A monitor assembly for a computer having a base, the monitor assembly comprising:
a lid attached to the base;
a screen assembly slidably attached to the lid; and
an actuating mechanism coupled between the screen assembly and the lid connected to slide the screen assembly between a lowered position and a raised position.

2. A monitor assembly according to claim 1 wherein the screen assembly comprises a screen, a frame, and a thin backing made from a lightweight, high-strength material.

3. A monitor assembly according to claim 1 wherein the screen assembly comprises T-rails and the lid comprises T-slots which slidingly receive the T-rails.

4. A monitor assembly according to claim 1 wherein the lid comprises T-rails and the screen assembly comprises T-slots which slidingly receive the T-rails.

5. A monitor assembly according to claim 1 wherein the lid comprises flanges on lateral edges thereof for slidably receiving the screen assembly.

6. A monitor assembly according to claim 1 wherein the actuating mechanism comprises:
a motor attached to the lid, the motor having a drive shaft; and
at least one worm gear attached to the drive shaft.

7. A monitor assembly according to claim 6 wherein the actuating mechanism comprises at least one lifter gear rotationally attached to the lid and operatively coupled to the worm gear, the lifter gear having a pin near an outer edge thereof, and wherein the screen assembly comprises a slot configured to slidably receive the pin of the lifter gear, whereby rotational motion of the motor is translated into linear motion of the screen assembly.

8. A monitor assembly according to claim 7 wherein the actuating mechanism comprises a meshing gear in engagement between the worm gear and the lifter gear.

9. A monitor assembly according to claim 7 wherein the at least one worm gear comprises two worm gears, with one of the two worm gears having a right handed helix and the other of the two worm gears having a left handed helix, and wherein the at least one lifter gear comprises two lifter gears, each of the two lifter gears operatively coupled to be driven by one of the two worm gears.

10. A monitor assembly according to claim 9 wherein the actuating mechanism comprises a meshing gear in engagement between each of the two worm gears and the associated lifter gear.

11. A monitor assembly according to claim 10 wherein each lifter gear and meshing gear has a plurality of holes therein for reducing a weight of the monitor assembly.

12. A monitor assembly according to claim 10 wherein each lifter gear and meshing gear has a cross-section which is thin relative to a thickness of the monitor assembly.

13. A monitor assembly according to claim 1 wherein the actuating mechanism comprises a member pivotally mounted to the lid, a pin projecting from the member into a transversely extending slot on the screen assembly and a mechanism connected to pivot the member relative to the lid.

14. A monitor assembly according to claim 1 wherein the actuating mechanism comprises a pair of members pivotally mounted to the lid, a pin projecting from each member into a pair of transversely extending slots on the screen assembly and a mechanism connected to pivot the members relative to the lid.

15. A monitor assembly according to claim 14 wherein the pair of members comprise lifter gears and the mechanism comprises a pair of worm gears connected to drive the lifter gears.

16. A monitor assembly according to claim 7 wherein the lifter gear comprises a large diameter lifter gear, and wherein a distance between the raised position and the lowered position is approximately equal to the large diameter.

17. A monitor assembly according to claim 16 wherein the large diameter lifter gear provides a low overall gear ratio such that the motor has low power requirements.

18. A monitor assembly according to claim 7 wherein the worm gear prevents the screen assembly from moving unless the motor is turned.

19. A monitor assembly according to claim 7 comprising a limit switch in the slot connected to stop the motor from turning when the pin engages the limit switch.

20. A monitor assembly according to claim 6 wherein the motor and drive shaft are located below the screen assembly.

21. A monitor assembly according to claim 10 wherein the motor and drive shaft are located below the screen assembly and positioned directly below the meshing gears.

22. A monitor assembly according to claim 1 wherein the actuating mechanism comprises a motor coupled to drive a pair of worm gears by means of a right-angle drive, and a pair of lifter gears operatively coupled to the pair of worm gears.

23. A monitor assembly according to claim 22 wherein the right-angle drive comprises a helical gear.

24. A monitor assembly according to claim 10 wherein the lifter gears are replaced by eccentric cams.

25. A monitor assembly according to claim 6 wherein the motor is a brushless motor.

26. A monitor assembly according to claim 1 wherein the actuating mechanism comprises at least one cam-shaped lifter member that rotates within a cam-shaped or circular static cut-out within the screen assembly.

27. A monitor assembly according to claim 10 wherein the actuating mechanism comprises a motor mount moveable between an engaged position wherein the worm gears engage the meshing gears and a disengaged position wherein the worm gears do not engage the meshing gears to facilitate manual actuation of the screen assembly in the event of a power failure.

28. A monitor assembly according to claim 27 wherein the sliding motor mount comprises an eccentric cam mechanism attached to the lid to selectively disengage the motor and worm gears from a locked position with the meshing gears.

29. A monitor assembly according to claim 28 wherein the lifter gears are interlocking to allow for proper re-alignment in the event that the worm gears are disengaged from the meshing gears during manual lowering of the screen assembly.

30. A monitor assembly according to claim 1 comprising one or more stabilizing components mounted on a rear lateral aspect of the base.

31. A monitor assembly according to claim 30 wherein the stabilizing components comprise vertical hinges that lock in position once rotated outward by 90 degrees relative to the base.

32. A monitor assembly according to claim 1 comprising a document holder comprising:
a compartment attached to a top of the screen assembly; and
a holding member comprising means of holding a document, the holding member movable between an extended position wherein the holding member can hold the document, and a retracted position wherein the holding member is housed within the compartment.

33. A monitor assembly according to claim 32 wherein the holding member comprises:
a first rectangular member slidably received in the compartment;
a second rectangular member slidably and pivotally coupled to a middle portion of the first rectangular member at a first end thereof; and,
a “J”-shaped shelf foldably attached to a second end of the second rectangular member.

34. A monitor assembly according to claim 33 wherein the second rectangular member comprises a slot in the first end thereof, comprising a thumb screw for selectively holding the second rectangular member in fixed relation to the first rectangular member.

35. A monitor assembly according to claim 33 wherein the first rectangular member comprises a generally vertically oriented hinge.

36. A monitor assembly according to claim 32 comprising a spring for biassing the holding member into the extended position.

37. A monitor assembly according to claim 32 wherein the compartment is defined in a housing, the housing being selectively detachable from the screen assembly.

38. A monitor assembly according to claim 1 comprising a document holder mounted to and moveable with the screen assembly.

39. A laptop computer comprising:
a base;
a lid pivotally coupled to the base;
a screen assembly slidably attached to the lid; and
an actuating mechanism coupled between the screen assembly and the lid connected to slide the screen assembly between a lowered position and a raised position.

40. A monitor assembly for a computer having a base, the monitor assembly comprising:
a lid attached to the base;
a screen assembly slidably attached to the lid; and
means for sliding the screen assembly between a lowered position and a raised position.
